(19) United States
(12) Patent Application Publication
(10) Pub. No.: US 2024/0216202 A1
(43) Pub. Date: Jul. 4, 2024

(54) FOLDABLE DEVICE FOR ISOLATING A PATIENT

(71) Applicant: REKREANDO, S.L., Donostia (ES)

(72) Inventors: Jose Enrique FERNANDEZ ENTENZA, Donostia (ES); David PEREZ SAEZ, Donostia (ES)

(21) Appl. No.: 18/558,314

(22) PCT Filed: May 4, 2021
(86) PCT No.: PCT/ES2021/070303

§ 371 Date: Oct. 31, 2023

(51) Int. Cl. A61G 10/00

(52) U.S. Cl. CPC A61G 10/005

(57) ABSTRACT

Foldable device for isolating a patient, comprising a chamber (2) having a wall (21) that defines, in an unfolded position, a region (3) for receiving and isolating a patient, a base (1) on which the patient is placed in the unfolded position, and a support structure (4) for holding the wall (21) of the chamber (2), wherein the base (1) comprises contiguous modules in a longitudinal direction which allow the base (1) to be folded between contiguous modules.

### TECHNICAL FIELD

The present invention relates to devices for isolating patients.

### PRIOR ART

Today, the spread of infections in ambulances, hospitals, and health care facilities poses a significant problem. For example, when transferring a patient infected by a highly contagious infectious agent to a hospital, there is a need to safeguard the health and safety of the health professionals and doctors accompanying the patient.

The most common safety mechanisms are the use of personal protective equipment, such as gloves, masks, coveralls, or goggles, among others. These pieces of equipment protect the user against one or more risks, in this case, the infectious agent, that may put their health and safety at risk. Nevertheless, once the patient is transferred, the area and surfaces where the patient has been on must then be disinfected.

Another alternative is to isolate the patient in an isolation device.

EP959863A1 describes a foldable device having a chamber the wall of which defines, in an unfolded position, a region for receiving and isolating a patient who is lying down, a base on which the patient is placed, and a support structure for holding the wall of the chamber, wherein the base and the support structure are communicated and inflated at the same time, for example, by supplying air through a hole.

CN111513959A describes a biosafety type transfer unit comprising an isolation cabin body which is provided with a seat, a power supply, and an illuminating lamp.

### DISCLOSURE OF THE INVENTION

The object of the invention is to provide a device for isolating a patient, as defined in the claims.

One aspect of the invention relates to a foldable device for isolating a patient, comprising a chamber the wall of which defines, in an unfolded position, a region for receiving and isolating a patient, a base on which the patient is placed in the unfolded position, and a support structure for holding the wall of the chamber, wherein the base comprises in a longitudinal direction contiguous modules which allow said base to be folded between contiguous modules.

This arrangement of the base allows the base to be adapted to the surface on which the device is supported when in use, with the isolated patient feeling comfortable while being isolated inside the device, when he or she is transferred sitting up, for example, on the seat of a train, or lying down when he or she is transferred on a stretcher. This arrangement of the base furthermore allows the device to be folded in a simpler manner.

These and other advantages and features of the invention will become apparent in view of the figures and detailed description of the invention.

### DESCRIPTION OF THE DRAWINGS

FIG. 1 shows a side view of the device according to an embodiment of the invention, in an unfolded position.

FIG. 2 shows a front view of the device according to the embodiment of FIG. 1.

FIG. 3 shows a view of the support structure in a folded position according to an embodiment of the invention.

FIG. 4 shows a perspective view of the device according to an embodiment of the invention.

FIG. 5 shows a depiction of the device in a folded position according to an embodiment of the invention.

FIG. 6 shows the device of the preceding figure inside a portable bag according to an embodiment of the invention.

### DETAILED DISCLOSURE OF THE INVENTION

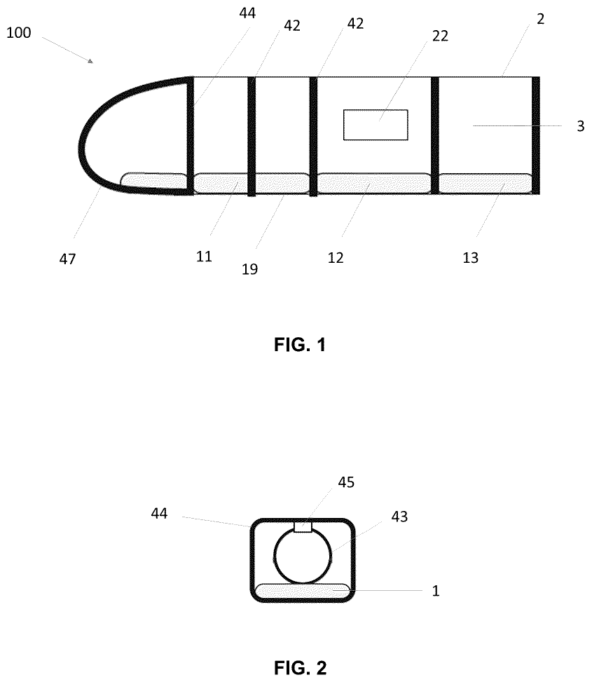

As shown in FIG. 1, the foldable device 100 of the invention comprises a chamber 2 the wall 21 of which defines, in an unfolded position, a region 3 for receiving and isolating a patient, a base 1 on which the patient is placed in the unfolded position, and a support structure 4 for holding the wall 21 of the chamber 2. The base 1, preferably arranged inside the chamber 2, comprises in a longitudinal direction contiguous modules which allow said base 1 to be folded between contiguous modules. This feature allows the base 1 to be arranged in several positions, adopting the position of the surface on which the patient will be placed.

In a preferred embodiment, in the unfolded position the base 1 comprises in the longitudinal direction at least a first segment 11 for supporting the head and back area, a second segment 12 for the buttock and thigh area, and a third segment 13 for the legs, the contiguous segments 11, 12, 13 being delimited between contiguous modules.

With respect to the modules, in a preferred embodiment, the modules of the base 1 are inflatable, preferably by means of the introduction of air or gas through an inflating and deflating nozzle located in the base 1.

In a preferred embodiment, these modules can be inflated completely, or depending on the patient's posture (sitting up or lying down), only those modules that are necessary for patient comfort can be inflated. For this last embodiment, in case of inflating with air or gas, each module would comprise its own inflating and deflating nozzle.

In terms of the shape of the modules, in a preferred embodiment, the modules are cylindrical and arranged transversely, each segment 11, 12, 13 comprising a plurality of modules for greater patient comfort.

With respect to the wall of the chamber 2, it is preferably made of a flexible material, very preferably PVC. To facilitate communication with the patient, the wall of the chamber 2 is preferably transparent. The wall of the chamber 2 may comprise at least one pocket 22, shown in FIG. 1, for holding the patient's belongings or documentation related with the patient.

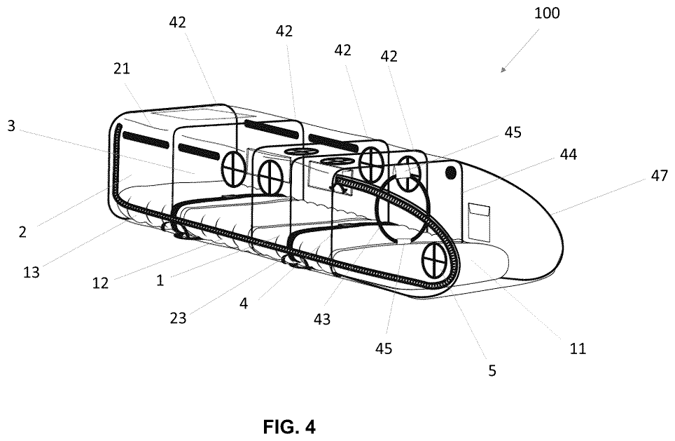

In a preferred embodiment, the support structure comprises a plurality of profiles 42 which, in the unfolded position, are spaced from one another in different positions in the longitudinal direction, keeping the wall 21 of the chamber 2 expanded, as can be observed in FIGS. 1 and 4. In a preferred embodiment, the plurality of profiles 42 support the base 1, i.e., the plurality of profiles 42 surround the base of the base 1. Preferably, the profiles 42 are fixed to the wall 21 of the chamber 2 and/or to a lower or outer face 19 of the base 1. This embodiment improves the expansion of the wall 21 of the chamber 2 in the unfolded position. Additionally, the base of the device comprises handles 23 so that the health personnel can use them to move the unfolded device from its place.

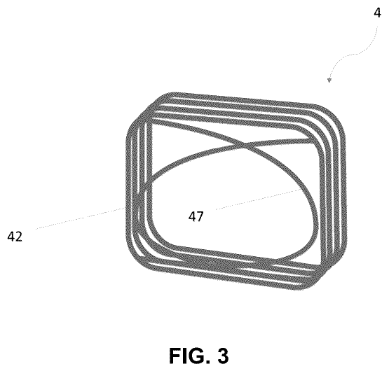

In a preferred embodiment, as shown in FIGS. 2 and 4, the device comprises, inside the chamber 2, a support profile 43, preferably circular, similar to a rigid collar, such that in the unfolded position the patient's head is introduced through said support profile 43, said support profile 43 being attached by at least one holding means 45 to a transverse profile 44 of the support structure 4 which in the unfolded position is arranged substantially at the height of the patient's shoulders or neck and/or to the base 1 substantially at the height of the patient's shoulders or neck in an unfolded position.

To better fold the support structure and to better hold the wall of the chamber around patient's head, in one embodiment, the support structure comprises two side profiles 47 delimiting in the chamber 2 an area for the patient's head, the side profiles 47 being attached to the profile 44 which, in the unfolded position, is arranged at the height of the patient's shoulders, the side profiles 47 being configured for being pivoted onto the rest of the profiles 42, 44 of the structure support when the device is to be arranged in a folded position. In another preferred embodiment, the support structure comprises, at one end of the chamber 2, a transverse profile 42 delimiting, together with the profile 44 which in the unfolded position is arranged at the height of the patient's shoulders, an area for the patient's head, both profiles 42, 44 preferably being attached by means of longitudinal ribs.

The profiles 42, 44, 47 of the different embodiments are preferably flexible rods with the advantage that they take up less space and are easy to fold and unfold, in addition to allowing the chamber to have certain flexibility, as shown in FIG. 3.

In terms of the transverse profiles, in a preferred embodiment, said transverse profiles have a substantially rectangular shape, therefore making the chamber 6 in which the patient will be housed a rectangular structure.

As mentioned, the device of the invention can be folded and unfolded. In a preferred embodiment, the folding of the device is performed by means of the superposition of the profiles 42, 43 after introducing at least one part of the wall 21 of the chamber 2 and the base 1 into the region 3 of the chamber 2.

In a preferred embodiment, the wall 21 of the chamber comprises at least one opening 5 for an air filter which allows the ventilation of the inside of the chamber or a cover which allows the health personnel to introduce his or her hand and part of his or her arm for handling the patient inside the chamber. In a preferred embodiment, the filter acts as a cover which can be removed from the housing when the health personnel needs to handle the patient and then said filter can be placed back in the housing 5.

In terms of the way in which the patient is introduced inside the chamber 6, in a preferred embodiment, the wall 21 of the chamber 2 comprises a longitudinal opening 22 which can be closed and through which the patient is introduced into the region 3. This closure is preferably hermetic, such that it prevents any leakage of contaminants or infectious agents coming from of the isolated patient.

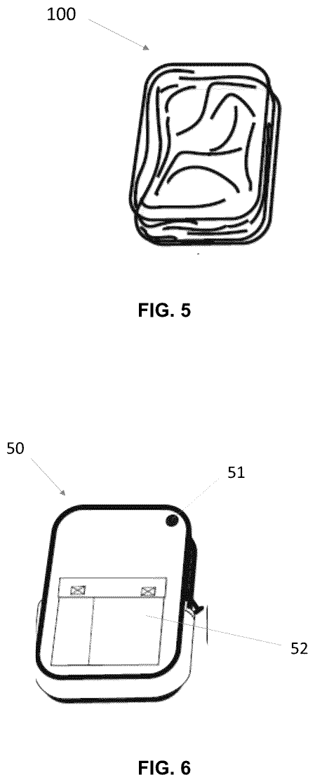

In terms of device portability, as described above, the device is foldable. In a preferred embodiment as shown in FIG. 5, the device comprises a portable bag in which the chamber 2, the base 1, and the support structure 4 are carried in a folded position.

In a preferred embodiment, this portable bag is furthermore a sanitization capsule for sanitizing the device, the bag comprising a closure which allows enclosing the device inside the bag and a nozzle for introducing a sanitization solution into the bag, thereby sanitizing and cleaning the device in a simple manner for subsequent use with another patient.

1. A foldable device for isolating a patient, comprising a chamber (2), a wall (21) of which defines in an unfolded position a region (3) for receiving and isolating a patient, a base (1) on which the patient is placed in the unfolded position, and a support structure (4) for holding the wall (21) of the chamber (2), wherein the base (1) comprises in a longitudinal direction contiguous modules which allow said base (1) to be folded between contiguous modules.

2. The device according to claim 1, wherein the modules of the base (1) are inflatable.

3. The device according to claim 1, wherein in the unfolded position the base (1) comprises in the longitudinal direction at least a first segment (11) for supporting the head and back area, a second segment (12) contiguous to the first segment (1) for the buttock and thigh area, and a third segment (13) contiguous to the second segment (12) for the legs, said contiguous segments (11, 12, 13) being delimited between contiguous modules.

4. The device according to claim 3, wherein the modules of the base (1) are cylindrical and arranged transversely, with each segment (11, 12, 13) comprising a plurality of modules.

5. The device according to claim 1, wherein the base (1) is arranged inside the chamber (2).

6. The device according to claim 1, wherein the wall of the chamber (2) is made of a flexible material, preferably PVC.

7. (canceled)

8. The device according to claim 1, wherein the support structure comprises a plurality of profiles (42) which, in the unfolded position, are spaced from one another in different positions in the longitudinal direction, keeping the wall (21) of the chamber (2) expanded.

9. The device according to claim 8, wherein the plurality of profiles (42) support the base (1).

10. The device according to claim 8, wherein the profiles (42) are fixed to the wall (21) of the chamber (2) and/or to a lower or outer face (19) of the base (1).

11. The device according to claim 8, comprising a preferably circular support profile (43) inside the chamber (2), the support profile (43) being configured so that, in the unfolded position, the patient's head is introduced through said support profile (43), said support profile (43) being attached by at least one holding means (45) to a transverse profile (44) of the support structure (4) which, in the unfolded position, is arranged at the height of the patient's shoulders and/or to the base (1) at the height of the patient's shoulders or neck.

12. The device according to claim 11, wherein the holding means (45) is a clamp attached to the transverse profile (44) or to the base (1) defining a housing in which the support profile (43) is partially housed.

13. The device according to claim 11, wherein the support structure comprises two side profiles (47) demarcating in the chamber (2) an area for the patient's head, the side profiles (47) being attached to the profile (44) which, in the unfolded position, is arranged at the height of the patient's shoulders, the side profiles (47) being configured for being pivoted onto the rest of the profiles (42, 44) of the structure support when the device is folded.

14. The device according to claim 11, wherein the support structure comprises, at one end of the chamber (2), a transverse profile (42) delimiting, together with the profile (44) which in the unfolded position is arranged at the height of the patient's shoulders, an area for the patient's head, both profiles (42, 44) preferably being attached by means of longitudinal ribs.

15. The device according to claim 8, wherein the profiles (42, 44, 47) are flexible rods.

16. The device according to claim 8, wherein the transverse profiles (42, 44) have a substantially rectangular shape.

17. The device according to claim 8, wherein the folding of the device is performed by means of the superposition of the profiles (42, 43) after introducing at least one part of the wall (21) of the chamber and base (1) into the region (3) of the chamber (2).

18. The device according to claim 1, wherein the wall (21) of the chamber (2) comprises at least one opening (5) for housing an air filter which allows the ventilation of the inside of the chamber (2) or a removable cover.

19. The device according to claim 18, wherein the filter housed in the opening (5) is removable.

20. The device according to claim 1, wherein the wall (21) of the chamber (2) comprises a longitudinal opening (22) which can be closed and through which the patient is introduced into the region (3).

21. The device according to claim 1, comprising a portable bag in which the chamber (2), the base (1), and the support structure (4) are carried in a folded position, and wherein the bag comprises a nozzle for introducing a sanitization solution into the bag.

22. (canceled)
